(19) United States
(12) Patent Application Publication
(10) Pub. No.: US 2010/0285388 A1
(43) Pub. Date: Nov. 11, 2010

(54) CATALYST-COATED PROTON EXCHANGE MEMBRANE AND PROCESS OF PRODUCING SAME

(75) Inventors: William H. Schank, Howell, MI (US); Patrick Bouchard, Shawinigan (CA); Mario Boucher, Saint-Etienne-Des-Gres (CA); Philippe Bebin, Quebec (CA); Marin Lagace, Saint-Bruno-de-Montarville (CA); Pierre Hovington, Boucherville (CA)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: SIM COMPOSITES INC., Saint-Augustin-de-Desmaures, QC (CA)

(21) Appl. No.: 12/600,528

(22) PCT Filed: May 16, 2008
(86) PCT No.: PCT/CA08/00955

§ 371 Date: Jul. 13, 2010

Related U.S. Application Data
(60) Provisional application No. 60/938,823, filed on May 18, 2007.

(51) Int. Cl. H01M 8/10

(52) U.S. Cl. 429/483; 429/482; 429/535; 204/192.11

(57) ABSTRACT

The catalyst-coated membrane has a proton exchange membrane with two opposite sides, and a catalyst coating applied directly to one of the two sides, the catalyst coating having a plurality of openings defined therethrough and scattered thereacross, the openings defining passages to the proton exchange membrane in which corresponding electro-chemical active surfaces of the catalyst coating are exposed. The openings can be defined in the catalyst coating after application thereof or during application thereof.

### FIELD

The specification generally relates to a catalyst-coated proton exchange membrane, such as those used in fuel cells for example, and more particularly to a catalyst-coated proton exchange membrane in which the catalyst coating has openings defined therethrough.

### BACKGROUND

Diminishing hydrocarbon resources, pollution caused by internal combustion engines and other energy producing uses of hydrocarbon fuels, and increasing prices of crude oil have led to intensified research and development activities with the object of finding viable alternatives to internal combustion engines and hydrocarbon fueled energy producing devices. One of the most recognized proposed alternatives is the use of hydrogen fuel cells.

FIG. 1 shows a typical configuration of a fuel cell 210. A fuel cell is an electrochemical energy conversion device. A PEM fuel cell 210 uses a proton exchange membrane 212 (PEM) which is electrically insulating, but proton conductive. Generally, a conventional proton exchange membrane 212 for a fuel cell 210 has two flow field plates 214, 216 on opposite sides, namely an anode flow field plate 214 and a cathode flow field plate 216, which are generally made of carbon, graphite or metal. A membrane electrode assembly 218 (MEA) generally includes two gas diffusion media or layers 220, 222 (GDL), two layers of catalyst-containing media or electrodes 224, 226, and the proton conducting membrane 212, and is generally sandwiched between the flow field plates 220, 222. The gas diffusion layer 220, 222 enables diffusion of the appropriate gas, either a fuel or an oxidant, to the surface of the proton exchange membrane 212 and the catalyst-containing layer 224, 226. At the same time it provides for conduction of electricity between the associated flow field plate 214, 216 and the catalyst-containing layer 224, 226.

In use, a fuel flows on the anode side, and an oxidant flows on the cathode side. The fuel dissociates into protons and electrons on the anode side, and the protons are carried through the proton conductive membrane to the cathode side, where they combine with the oxidant and the electrons which travel from the anode, through an external circuit, to the cathode, where they react with the protons and oxidant to recombine. The electrons are prevented from passing through the membrane, and a difference of potential (voltage) is created between the cathode and the anode. Electrical power can thus be extracted from the external circuit. The reactants flow in and the reaction products flow out while the electrodes and the proton exchange membrane remain substantially unaffected. In the case of a proton exchange membrane fuel cell (PEMFC), the reactants are hydrogen (H₂) and oxygen (O₂) (in air), and the reaction product is water (H₂O). A typical hydrogen fuel cell produces between about 0.3 and 0.9 volt. To create enough voltage for a particular need, the cells are layered and combined in series and in some applications, parallel circuits, to form a fuel cell stack. The number of cells used in a stack varies with design and requirement. Other hydrogen containing reactants can also be used such as alcohols.

The catalyst coating used on the anode and cathode sides of the proton exchange membrane enables the operation of the fuel cell by allowing the chemical dissociation of the protons and electrons of the reactants and re-combination into the reaction products. Typically, in some proton exchange membrane fuel cells, generally spherical particles of a noble metal, such as platinum, palladium or gold are distributed in, or supported by, a carbon matrix. Platinum is a popular choice due to its exceptional catalytic capabilities. Traditionally, the catalyst-containing layer of a proton exchange membrane fuel cell is mostly carbon, which has the advantage of good electrical conduction properties, but the disadvantage of a tendency to corrode. Due to the carbon metrics in such a proton exchange membrane, and to the shape of catalyst particles in the matrix which does not optimize surface area, very little of the catalyst content is available on the surface for the catalytic reaction.

The costs of fuel cells is presently one of the greatest barriers preventing them from viably replacing internal combustion engines. One of the most important factors influencing their costs is the cost of the catalyst. Platinum, for instance, has more than tripled in price from about $12 US a gram in 1999 to about $43 US in 2006. For this reason, much research effort has been given finding satisfactory alternatives to precious metals as catalysts, or reducing the amount of catalyst needed in each individual cell. Although some progress has been made in recent years, further improvements are still required.

### SUMMARY

In accordance with one aspect, there is provided a proton exchange membrane having a catalyst coating which has openings defined therethrough, and scattered thereacross, the openings providing a passage to the proton exchange membrane and in which an electro-chemical active surface of the catalyst coating is exposed, and thereby providing reaction sites as defined further below. The catalyst coating can be on the anode side, on the cathode side, or both. Traditional catalysts, including other noble or non-noble catalysts, and new catalysts, as they are discovered or developed, can be used. The openings can be defined during application of the coating, or after the coating has been applied.

The amount of catalyst can be reduced by the use of a catalyst coating which can consist purely of catalyst with openings defined therethrough, instead of currently utilized methods, in which catalysts are supported on various forms of carbon, and in which catalysts are then processed into ink-like suspensions and applied by any one of numerous “printing” or “transfer” techniques.

The resultant catalyst coated membrane can, if desirable, have no carbon in the catalyst layer. The absence of carbon can eliminate a known problem of carbon corrosion and the resultant catalyst release, because carbon is subject to corrosion at the voltages at which the catalyst layer is exposed to in many fuel cell applications. Binders and fillers, which are the source of some known problems during fuel cell operational regimes, can also be avoided.

Further, in the current practice of the art the “ink” used in the preparation of the electrode layer contains a fluorine compound such as DuPont's Nafion™. The catalyst coated membrane described herein does not need this fluorine compound and therefore offers another advantage. The fluorine can, over time and use, be released from the “ink” and combine with the hydrogen to form a very corrosive acid which can cause damage to the cell components such as metal bipolar flow plates. In the embodiments which use a fluorine free, hydrocarbon-based membrane as the proton-exchange membrane, the resulting catalyst-coated membrane can be, if desired, fluorine free.

In accordance with another aspect, there is provided a catalyst-coated membrane comprising a proton exchange membrane having two opposite sides, and a catalyst coating applied directly to one of the two sides of the proton exchange membrane, the catalyst coating having a plurality of openings defined therethrough and scattered thereacross, the openings defining passages to the proton exchange membrane in which corresponding electro-chemical active surfaces of the catalyst coating are exposed.

In accordance with another aspect, there is provided a method of making a catalyst-coated membrane having a proton exchange membrane with two opposite sides, and a catalyst coating, the method comprising: applying a deliberately discontinuous layer of the catalyst coating directly onto the one of the two opposite sides of the proton exchange membrane in a manner that a plurality of scattered openings providing passages to the proton exchange membrane are defined through the applied catalyst coating, with electro-chemical active surfaces of the catalyst coating being exposed therein.

In accordance with another aspect, there is provided a method of making a catalyst-coated membrane having a proton exchange membrane with two opposite sides, and a catalyst coating, the method comprising: applying the catalyst coating directly onto one of the two sides of the proton exchange membrane; and subsequently defining a plurality of openings through the catalyst coating and scattered across the catalyst coating, thereby creating passages to the proton exchange membrane and exposing electro-chemical active surfaces of the catalyst coating.

In this specification, the expression “noble metal” refers to metals of group 7b, 8 and 1b, of the 2^{nd} and 3^{rd} transition series in the periodic table.

In this specification, the term “reaction site” is used to refer to an area that enables a reaction between the reactant (fuel or oxidant) and the catalyst while providing paths for electron conduction and proton movement through the membrane. Henceforth, the reaction site can be said to have an exposed electro-chemical active surface of the catalyst coating. The reaction sites collectively define the effective catalyst surface of the catalyst coated membrane. Achieving a greater amount of reaction sites generally yields a higher current density and a higher fuel cell performance. The expression electro-chemical active surface thus refers to a portion of the catalyst coating where the reaction can occur.

In this specification, the term “to abrade” is used in the sense: “to scrape away or wear down by friction; erode”. It is intended to include burnishing, especially because of the fineness of the abrasion involved herein, as will be detailed below.

### DESCRIPTION OF THE FIGURES

Further features and advantages will become apparent from the following detailed description, taken in combination with the appended figures, in which:

FIG. 1 illustrates a typical fuel cell in accordance with the prior art;

FIGS. 2A and 2B are schematic views of an example of a catalyst coated membrane, before and after burnishing, respectively;

FIGS. 3A, 3B, and 3C are schematic views of an other example of a catalyst coated membrane, before burnishing, during burnishing, and in use, respectively;

FIGS. 4A and 4B are two cross-sectional pictures of an example of a catalyst coated membrane, before burnishing;

FIGS. 5A and 5B are a top plan and a cross-sectional picture of an example of a catalyst coated membrane after burnishing;

FIG. 6 is a graphic performance curve of a catalyst coated membrane in a fuel cell;

FIGS. 7A to 7D are top plan pictures of examples of catalyst coated membranes, after laser ablation;

FIG. 8 is a graph showing the catalyst coverage rate distribution after laser ablation;

FIGS. 9 and 10 are graphic performance curves of examples of catalyst coated membranes in a fuel cell;

FIG. 11 is a top plan picture of an other example of a catalyst coated membrane;

FIGS. 12 to 14 are graphic performance curves of examples of catalyst coated membranes in a fuel cell.

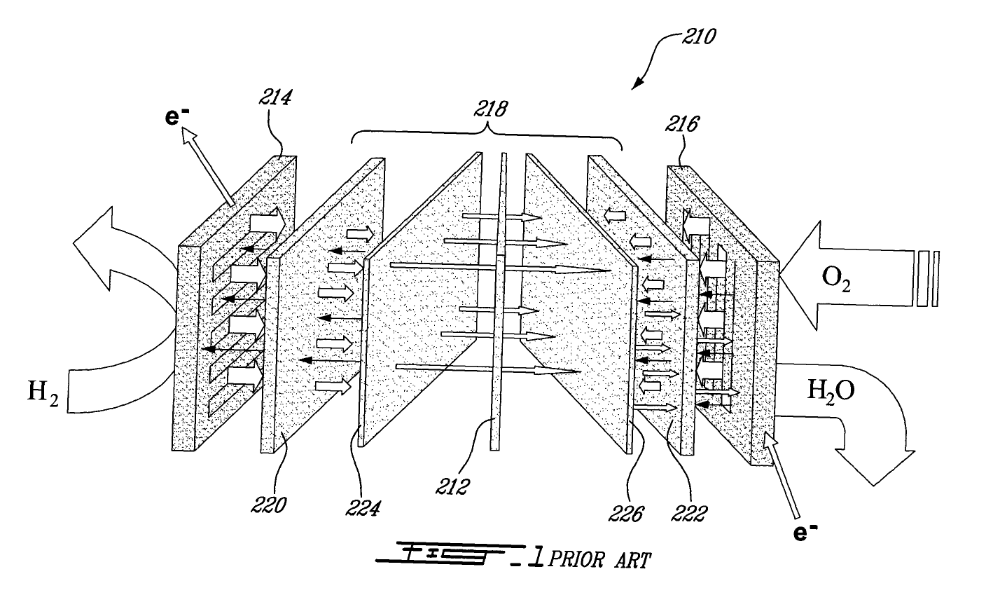

### DETAILED DESCRIPTION

The embodiments described below and illustrated give examples of several different methods by which can be created a catalyst-coated membrane in which a proton exchange membrane has a catalyst coating with scattered openings defined therethrough, and where the openings provide fluid passages to the proton exchange membrane and reaction sites where electro-chemical active surfaces of the catalyst coating are exposed. Also presented below are performance curves obtained by fuel-cell tests of examples of catalyst-coated proton exchange membranes produced by some of the described methods.

A first group of such methods involves coating the proton exchange membrane with catalyst first, and creating the openings in the catalyst coating which was previously applied. The catalyst coating, prior to the creation of the openings in such cases, can be continuous or discontinuous (i.e. some openings can already be present). The creation of the openings in the catalyst coating can be made in many different ways, as will be apparent from the examples given below. For example, if the catalyst coating is applied on a rough surface, the catalyst coating will typically have a rough exposed surface. Abrading the high-points thereof can create openings which expose and electro-chemical active surface of the catalyst coating and the proton exchange membrane underneath, thereby creating reaction sites. The roughness in the proton exchange membrane can be inherent, or induced, such as by adding fine particles on the surface thereof, for example. In another example, cracks or fissures can be formed in the catalyst coating such as by swelling of the membrane, for example. The cracks or fissures can be guided by areas of the catalyst coating made deliberately weak. In still other examples, openings in the catalyst coating can be created by vaporizing portions of the catalyst coating such as by using a plasma beam, for instance, or by exposing the catalyst coating to an energy field such as sparks, corona treatment, electron beam, or laser beam.

Another group of methods which can be used involve applying the catalyst coating to the proton exchange membrane in a manner that it is made deliberately discontinuous, i.e. the catalyst coating applied already has openings therein exposing the proton exchange membrane and offering reaction sites.

Although most of the examples given below and illustrated are tested on the anode side of the proton exchange membrane, it will be understood that they can alternately be used on the cathode side of the proton exchange membrane as well. Typically, a person skilled in the art would tend to use a greater catalyst loading on the cathode side than on the anode side.

### EXAMPLES

### Example 1

### Creation of Openings Involving Abrading High Points of Catalyst Coating

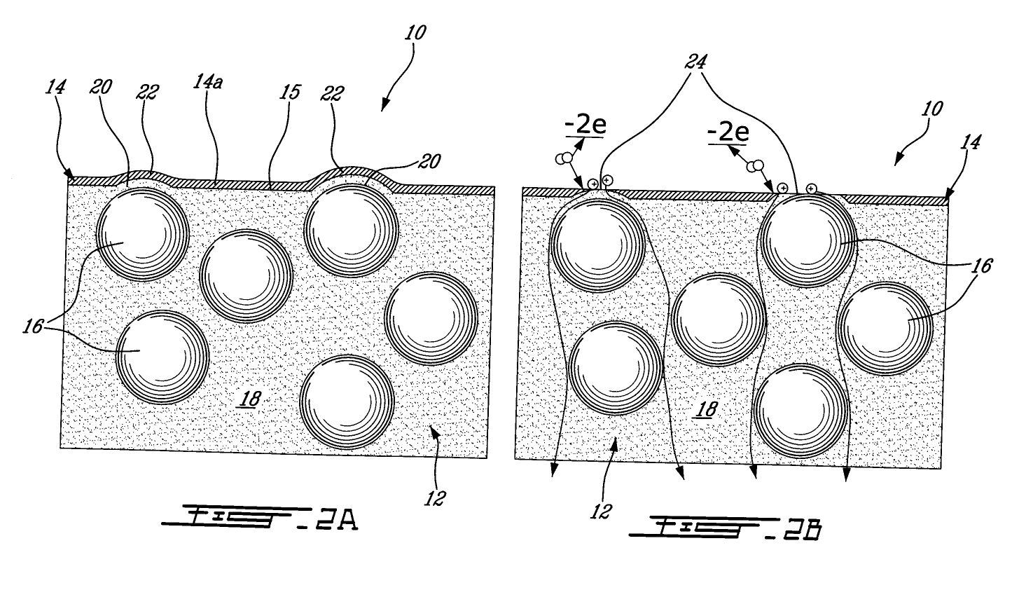

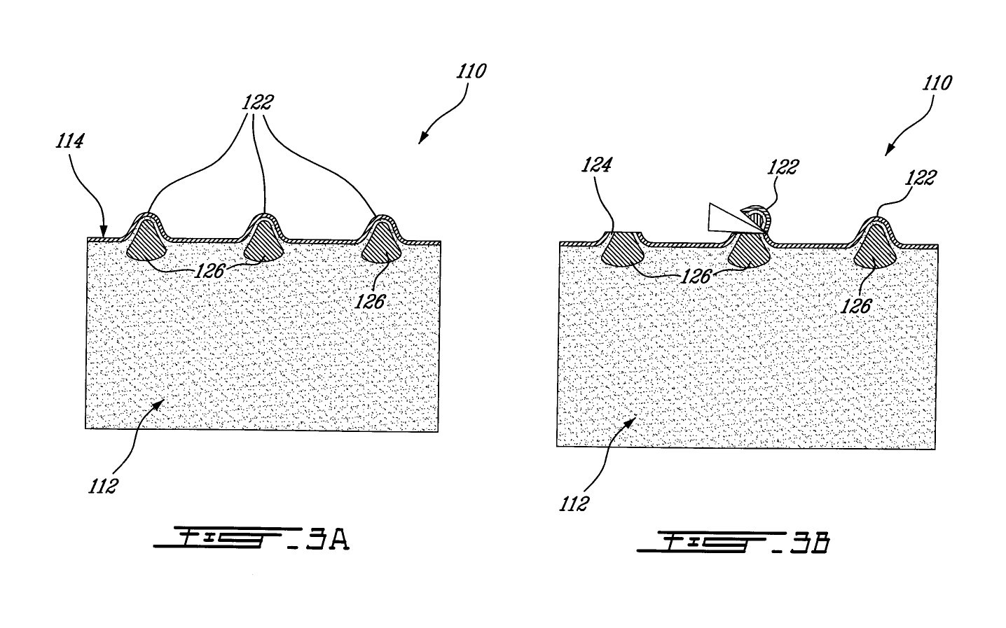

FIGS. 2A and 2B schematically show an example of an improved catalyst coated membrane 10 and a method of producing the same. In this example, the catalyst coated membrane 10 includes a proton exchange membrane 12 covered by a catalyst coating 14 on a catalyst-receiving surface thereof. The catalyst coating 14 can either be on the cathode side, on the anode side, or both. In this example, the catalyst coating 14 is a platinum coating 14a, and the proton exchange membrane 12 includes silica particles 16 in a polymer matrix 18. Some of the silica particles 16 adjacent the surface 15 on one side of the proton exchange membrane 12 define protrusions 20 on the surface 15, which can be characterized by a surface roughness. As will be seen below, the surface roughness can be made greater than the thickness of the catalyst coating 14.

FIG. 2A shows the catalyst coated membrane 10 before burnishing. The layer of catalyst coating 14 covers the protrusions 20 on the surface 15, and is thus also rough, including high points 22. The catalyst coating 14 is then abraded, or burnished, into the configuration illustrated in FIG. 2B. The high points 22 are removed. Openings 24, or pores, are thus created through the catalyst coating 14, exposing the proton exchange membrane 12 and defining catalytic reaction sites where molecular dissociation or recombination can occur.

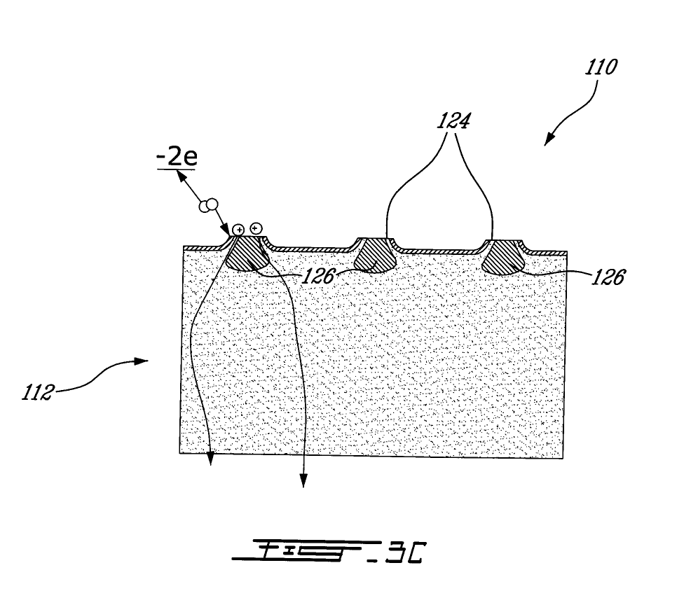

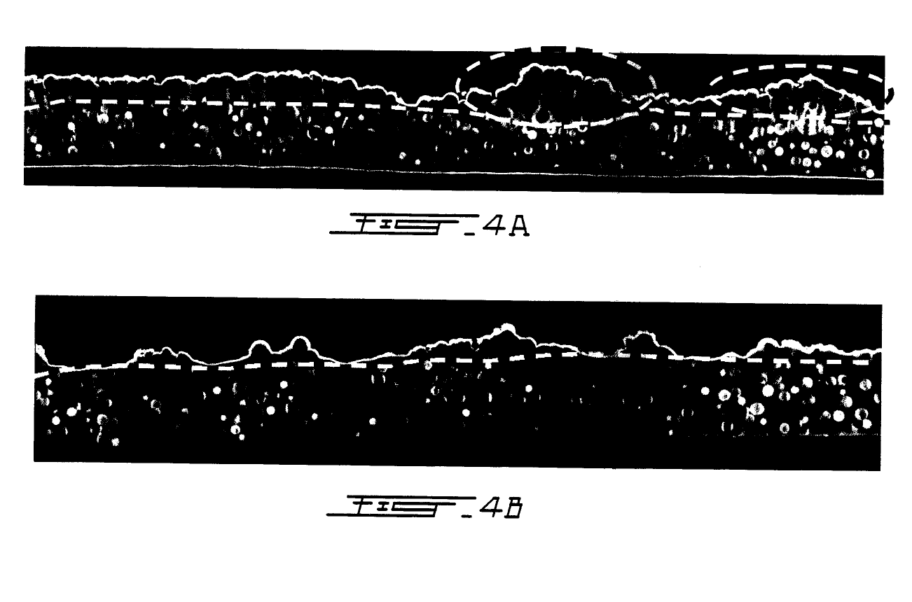

FIGS. 3A to 3C schematically show another example of a catalyst coated membrane 110. In this catalyst coated membrane 110, surface roughness of the proton exchange membrane 112 is increased by the deposition of inorganic particles 126 prior to coating with the catalyst 114, to create high points 122 in the catalyst coating. FIG. 3B depicts the abrading operation subsequent to catalyst coating, by which high points 122 are removed, thereby creating openings 124, and FIG. 3C schematizes the catalyst coated membrane 110 after abrading, in operation.

In this latter example of an improved catalyst coated membrane 110, the proton-exchange membrane can be hydrocarbon-based. A layer of inorganic particles 126 (such as fumed silica) forms a roughened surface on the membrane; and a thin layer of catalyst 114 (platinum in this case) applied to the rough surface, which is further treated to create openings 124 in the catalyst layer 114. The catalyst-coated membrane 110 does not require a carbon-based matrix or support for the catalyst 114 and can thus be carbon-free. The openings 124 are scattered across the planar surface of catalyst coating 114 in a manner that electric conductivity is maintained across the catalyst coating 114. In alternate embodiments, however, a layer of conductive material, such as nickel, carbon, copper for example, can be added to increase electrical conduction either within the catalyst layer or between the catalyst layer and the membrane. The conductive material can alternately be interspersed within the active catalyst material to improve conductivity. In this illustrated example, the catalyst coated membrane 110 does not include such an additional layer of conductive material. It will be noted here that instead of platinum, palladium, nickel, gold, and other noble or non-noble catalysts can also be satisfactory in certain applications.

The following steps can be used to create such a catalyst-coated membrane 110. After coating with inorganic particles, the proton exchange membrane, whose surface is then like very fine sand paper, can further be coated with a very thin layer of catalyst. After the catalyst coating process, the catalyst coated membrane is sanded with a very fine abrasive, or another technique is employed, which removes the catalyst from the high points of the coated abrasive-like proton exchange membrane surface, creating holes or pores in the proton exchange membrane, which, as further discussed below, creates reaction sites for catalyst and exposes the proton exchange membrane to allow passage of protons through the proton exchange membrane.

The resulting catalyst coated membrane has a proton exchange membrane with a catalyst coated surface with many very small openings, holes, or pores, in the coating. These small holes can be used as reaction sites for chemical fuel cell reactions, either on the anode side of the membrane, where hydrogen is catalyzed into protons that pass through the proton exchange membrane and electrons from which electrical power is extracted, on the cathode side, where oxygen molecules are broken into atoms and react with the protons and electrons to form water, or both. These small holes provide an advantageous reaction site because they expose the proton exchange membrane and the catalyst, while passages are provided both for the electrical current and the water by-product.

There are several ways that inorganic particles can be deposited on the proton exchange membrane surface: they can be sprayed on in a solution of solvent, which allows them to be imbedded into the proton exchange membrane surface when the solvent reacts with the proton exchange membrane polymer and softens the surface; or they can be sprayed on in a solution of the base membrane polymer and a solvent, or a solution of another polymer and solvent, which can act like a glue and leaves a very thin coating of polymer on the particles. Further techniques include softening the proton exchange membrane surface by applying a coating of solvent and dusting the softened membrane with the inorganic particles. In this method, the particle-coated proton exchange membrane can be calendared or pressed to push the inorganic particles into the proton exchange membrane surface to a desired amount, or the particles may be left on the surface. Particles can also be mixed into the membrane polymer before it is cast into a membrane and allowed to migrate to the surface during casting. Other techniques for applying inorganic particles to a surface can also be used.

In alternate embodiments, the layer of inorganic particles is optional altogether, and can be omitted when the proton exchange membrane used has a satisfactory surface roughness, or when the opening creation process does not require the presence of high points.

Several methods can be used to remove the high points of the catalyst coating. The catalyst-coated proton exchange membrane can be processed as a web using a counter- or cross-directional abrasive web or belt, i.e. burnishing. Alternately, the proton exchange membrane can be exposed to a gas-borne abrasive, such as sandblasting with very fine particles.

The catalyst coating can be deposited onto the proton exchange membrane by vacuum deposition, for example. Other satisfactory coating techniques such as chemical deposition, electro-chemical deposition, or sputter-coating, for example, can be used as well.

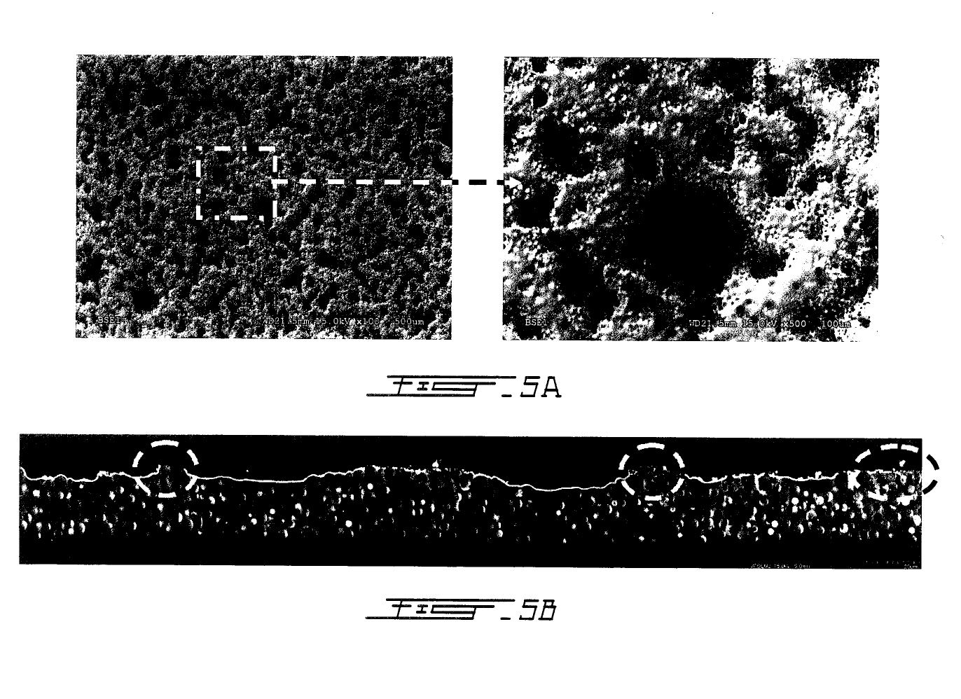

FIGS. 4A and 4B are through-plane MEB pictures of a example of a hydrocarbon-based composite membrane which was coated by a silica enriched phase. A solution of less than 1% of the membrane ionomer in NMP was enriched by 15% of silica particles (4 um in diameter) and 3% of fumed silica (7 nm in diameter). The solution was sprayed over the membrane for about 10 sec. Depending on the exposure time and on the amount of silica in the mixing, the thickness of the silica coating and the size of the agglomerates (shown circled by dashed lines in FIG. 4A) vary. The thickness of the silica layers can be seen (compared to the original surface of the membrane identified by dotted lines) for two different samples (FIG. 4A and FIG. 4B).

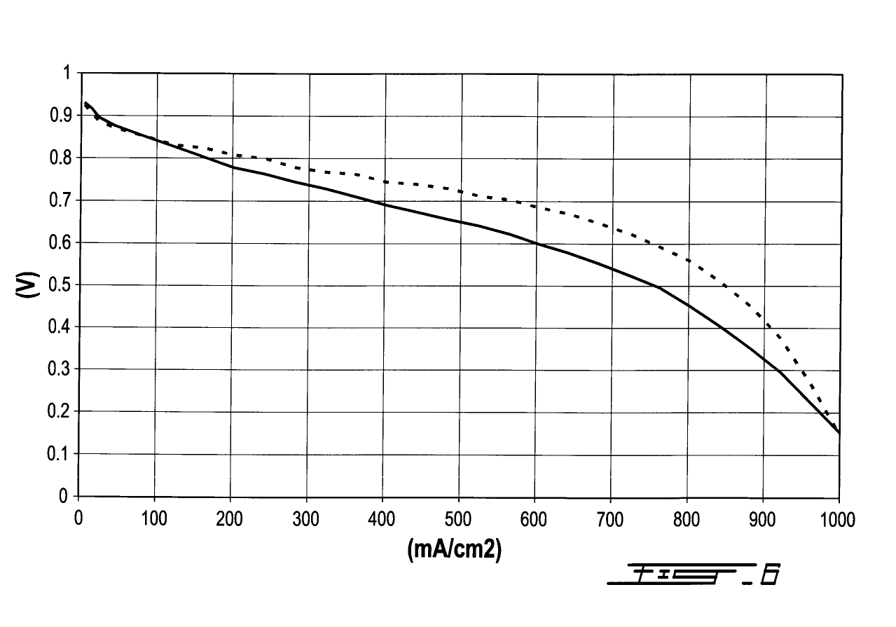

FIGS. 5A and 5B are in-plane and through-plane MEB pictures showing a hydrocarbon-based proton exchange membrane, which has received a continuous 25 nm coating of platinum (the catalyst coating) followed by mechanical abrasion. For this example, the membrane has a composite formulation and has been covered by additional silica particles to improve the silica loading at the top surface and to increase the amount of high points. The enriched inorganic phase can be seen in the through-plane picture (FIG. 5B). After the catalyst coating has been deposited, it was abraded using sand paper 4000 Grit to remove the platinum at the high points to create openings which give access (i.e. provide passages) to the membrane. The openings created in the catalyst coating can be seen in FIG. 5A and in FIG. 5B. In FIG. 5B, the openings (or absence of catalyst) is evidenced at the high points by circles in dashed lines.

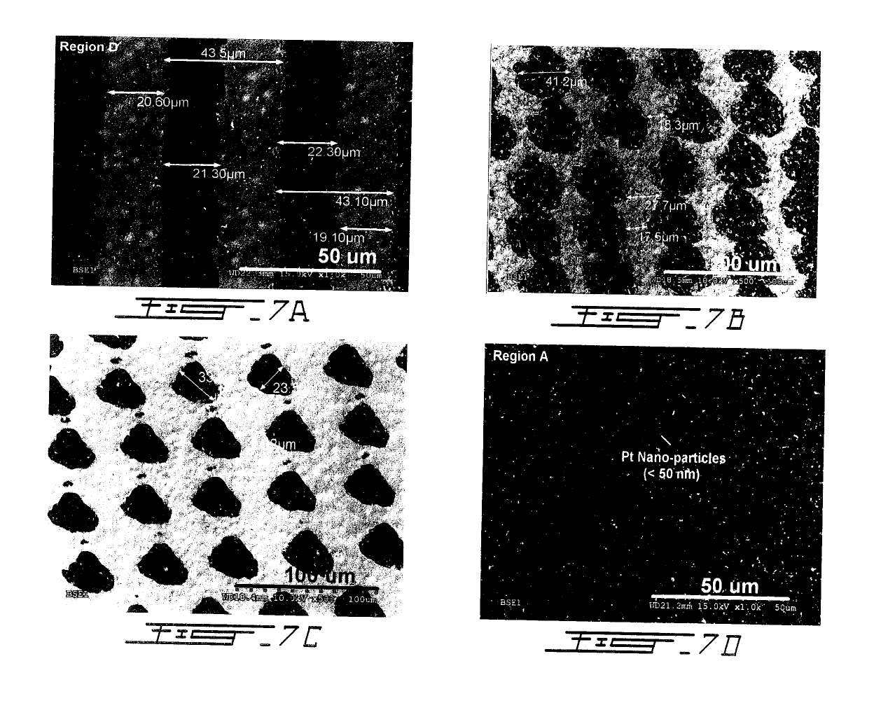

FIG. 6 shows a current density v. voltage curve (performance curve, or polarization curve) for a prototype sample (shown in solid line) of a hydrogen fuel cell with a catalyst coated membrane using enhanced silica surface and mechanical abrasion of the catalyst layer, i.e. a sample of the same type as the one illustrated in FIGS. 5A and 5B and described above. In this sample, silica particles were deposited at the top surface of the membrane on the anode side, then a catalyst coating of platinum was applied on the anode side, covering the membrane and silica particles, the silica particles inducing high points in the catalyst coating, then high points were removed by burnishing, creating openings in the catalyst coating. The catalyst coated membrane is tested in a fuel cell, on the anode side. The sample was tested at 70° C. with a hydrogen pressure of 200 kPa. Hydrogen flowed at 0.1 lpm on the anode side whereas air flowed at 0.4 lpm on the cathode side. In the sample, the anode catalyst coating is of 0.05 mg of platinum/cm² and the cathode has a commercial electrode having 0.5 mg of platinum/cm², and the total surface of the sample is of 5 cm². The performance curve of the test sample is compared to a reference curve (shown in dashed lines) in which a traditional electrode with carbon layer having 0.5 mg of platinum/cm² in suspension therein is used on the anode. It can be seen that the sample uses only 10% of the amount of platinum used in the reference sample, and comparable performance was nevertheless achieved. Further tests demonstrated that a reduction in the platinum loading (i.e. below 0.05 mg/cm²) generally resulted in a reduction in performance.

It will be noted that the performance curves obtained herein were achieved using a commercially available test cell rather than an optimized test cell. In this context, one skilled in the art will recognize the significant performance of the samples.

### Example 2

### Creation of Openings in the Catalyst Coating Using an Energy Field or Vaporizing

To create the openings, the proton exchange membrane can be exposed to electrical treatments, such as corona treatment or e-beam treatment; or the membrane can be exposed to high energy scattered laser beams applied in a way which does not penetrate the proton exchange membrane polymer, but causes the catalyst to be selectively removed to create the reactive sites on an abrasive-like membrane. Another method which can be used for removing small amounts of catalyst or making small holes in the platinum layer is by laser treatments creating patterned or random disruptions of the surface. This latter method can be used independently of high points of the surface, and can thus be performed to create pores through a relatively flat catalyst coating, and not necessarily in previously high points. This latter method can also be used without the intermediate step of adding inorganic particles to roughen the surface of the membrane.

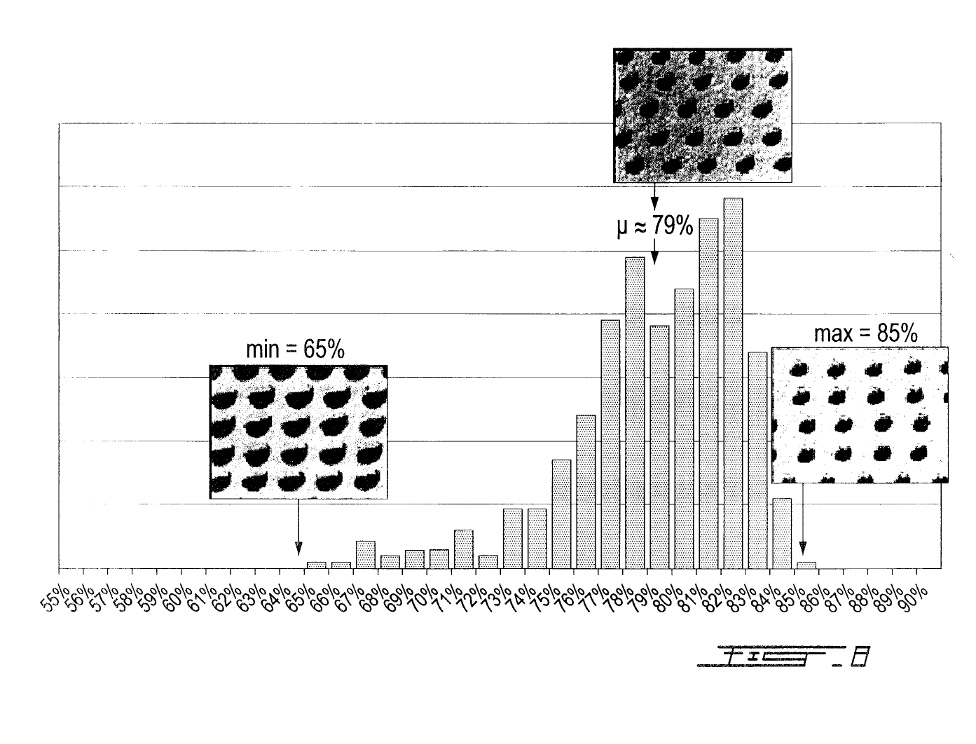

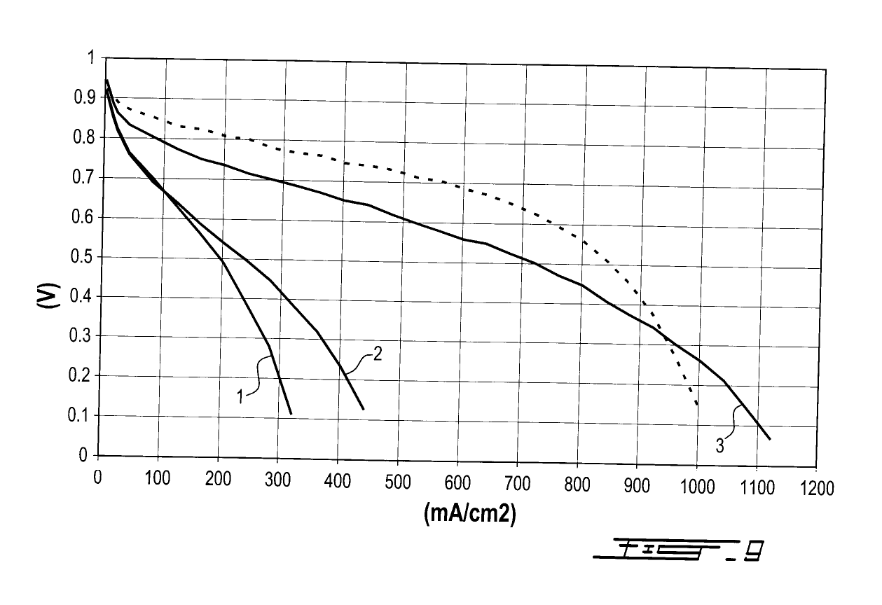

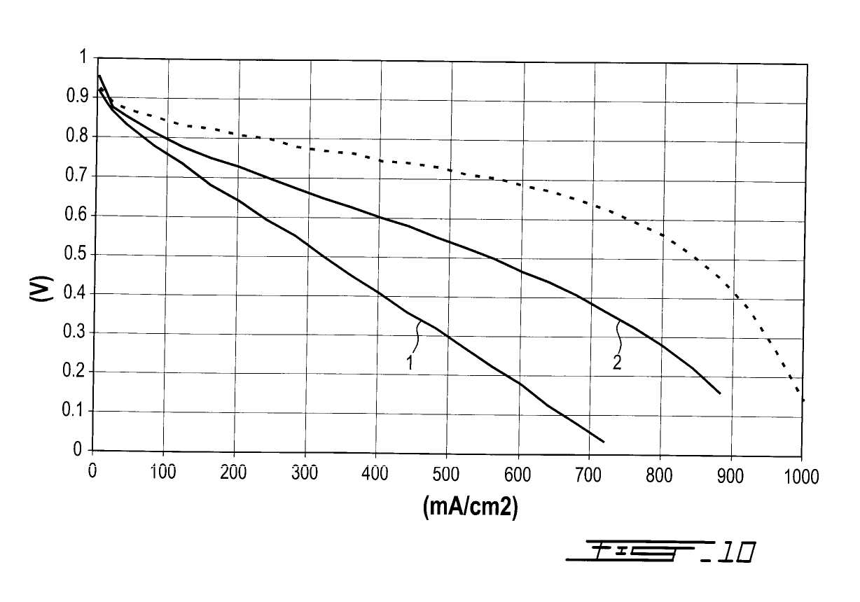

FIGS. 7A to 7D show some catalyst coating structures obtained after a laser treatment of a formerly continuous catalyst coating. In each of FIGS. 7A, 7B, 7C and 7D, platinum is used as the catalyst and the initial thickness of the catalyst coating is 25 nm. Depending on the parameters of the laser (mainly its displacement speed and its energy), the amount of the catalyst removed can vary from 100% to 0%. Line openings in the catalyst can be created at the top surface, such as presented in FIG. 7A. Dot openings can be created in the catalyst coating, providing passages allowing protons to reach the proton-exchange membrane, such as shown in FIGS. 7B and 7C. Alternately, such as shown in FIG. 7D, nanoparticles of catalyst can be left at the top surface of the membrane after a quite complete removal of the initial catalyst coating.

FIG. 8 shows the an example of a platinum coverage distribution on the surface of the proton exchange membrane after a given laser ablation treatment. In this case, the coverage by catalyst across the surface varies between 65% and 85% with a peak in coverage at about 83%. Averaging the distribution of Pt on all the surface of the sample gives an average percentage of 79% of the surface that is covered by platinum.

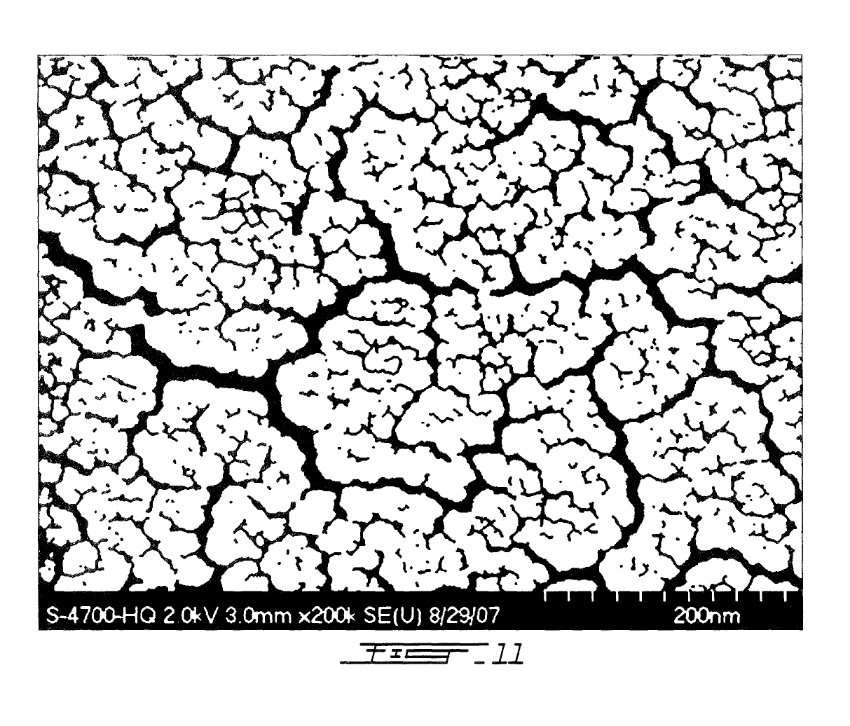

FIG. 9 shows fuel cell performance for catalyst-coated proton-exchange membranes in which a 25 nm thick continuous catalyst coating on the anode side was treated with laser ablation. In this example, the proton exchange membrane is hydrocarbon-based, without induced added roughness prior to catalyst deposition. The passages to the membrane are thus obtained with the laser ablation that creates openings in the platinum layer. Sample 3 has an opening configuration similar to the one illustrated in FIG. 9C, with an average platinum coverage of about 80%. Sample 1 has very irregular platinum coverage following the laser ablation. On sample 2, about 55% of the platinum has been removed by the laser, leaving about 0.025 mg Pt/cm². The distribution of platinum is also quite irregular in Sample 2 and the catalyst coverage ranges from 5% to 100%. Sample 3 presents the most controlled Pt coverage with about 0.04 mg Pt/cm² after an average of about 20% of platinum coverage is removed by laser. Moreover, the distribution of Pt on the complete surface of the sample ranges between 65% to 85%, such as shown in FIG. 8. These results show the importance of controlling the catalyst distribution on the surface for good performance.

Although the latter example is on the anode side, it will be understood that the catalyst coating can be used on the cathode side as well.

The catalyst material removed can be recovered and reprocessed in the methods used to remove it and form the reaction sites described above. In the mechanical approaches the abrasive can be cleaned and the metal reclaimed, in the airborne abrasive approach, the dust and metal can be processed, in any of the vaporization methods, the resulting gas can be condensed and processed.

### Example 3

### Creation of Crack Openings in the Catalyst Coating Using Swelling of the Membrane

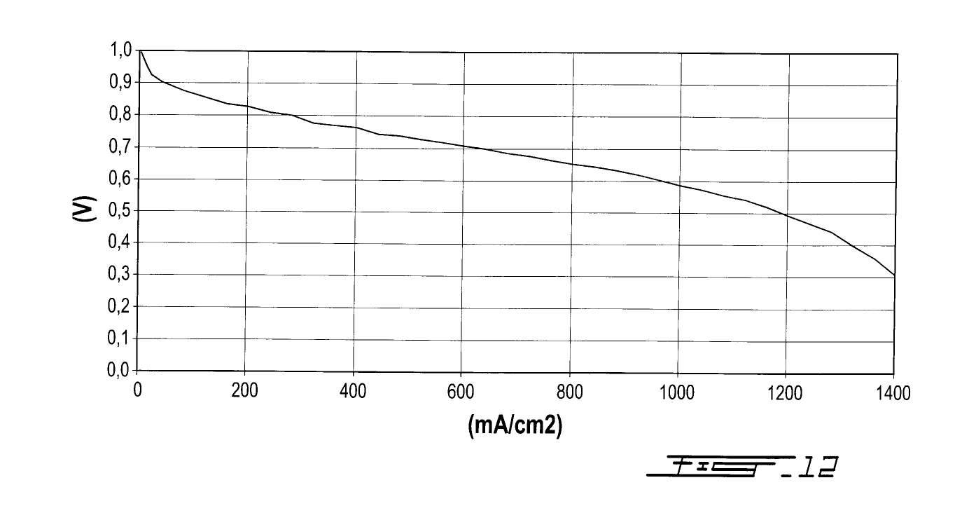

FIG. 10 presents the polarization curves obtained with uniform, 25 nm thick platinum coating on the anode side. In this example, openings in the form of cracks were made in the catalyst coating by heating and hydrating the membrane that expands by about 10% to 15%. A lot of cracks, of about 0.3 um to 3 um wide are produced in the catalyst layer, enabling the protons to pass through the membrane. It will be understood that in this example, the openings were thus not made by mechanical abrasion nor by laser ablation. For the samples of FIG. 10, two kinds of proton exchange membranes are used, in Sample 1, a fluorinated Nafion® 111 membrane is used, whereas in Sample 2, a hydrocarbon-based membrane is used. Roughness was not induced in the proton exchange membrane surface prior to catalyst deposition.

The thickness and the size of the openings created in the catalyst layer by any of the methods described above and its coverage over the membrane are relevant to performance. Typically, the thickness of the platinum layer can range between 1 to 150 nm, but is more generally around 25 nm. The size of the openings in the catalyst layer typically range from 50 nm to 10 um in the case of cracks, but can range between 0.1 to 50 um in the case of laser ablation or mechanical abrasion. The coverage of the catalyst over the membrane can be comprised between 20% and 99%, and preferably between 50 and 85%. When inorganic particles are deposited on the surface of the membrane prior to the catalyst deposition, the size of the particles should be comprised between 5 nm and 5 μm, preferably around 0.5 μm.

### Example 4

### Creation of Openings Upon Application of the Catalyst Coating

As demonstrated below, openings in the catalyst coating can alternately be provided upon application of the catalyst coating, i.e. already present once the catalyst coating has been applied, without the need to create them after deposition has been completed.

FIG. 11 shows an in-plane microphotograph of a proton exchange membrane (visible in black) with a deliberately discontinuous catalyst coating (visible in white). The proton exchange membrane is visible through a plurality of elongated, non-straight openings of varying widths and lengths, which are irregularly scattered on the catalyst-receiving surface (the exact shape of which is visible in black). The catalyst coating thereby forms an irregular agglomerational structure on the proton exchange membrane, having irregular, semi-contiguous agglomerations. In this specific example, the catalyst coating is of platinum, having a thickness of about 30 nm on average for the agglomerations. In the illustration, the ratio of the surface occupied by openings vs. surface occupied by platinum is about 25%. This ratio can vary between 10% and 30%, for example, in alternate embodiments. As it appears in the illustration, the elongated openings have a width varying between about 5 nm and 15 nm on average, whereas the agglomerations have an average width of between about 15 nm and 30 nm. In alternate embodiments, the average size of the openings and of the agglomerations, and the configuration thereof can vary.

This deliberately discontinuous catalyst coating shown in FIG. 11 was applied using the model K575X Turbo Sputter Coater manufactured by Emitech. The target used is a platinum disc having 57 mm in diameter. The proton-exchange membrane used is hydrocarbon-based. Those skilled in the art will appreciate that this sputter-coater is intended for use in creating uniform, continuous catalyst depositions. It was found that it could be operated to create a deliberately discontinuous coating when the argon pressure in the chamber was set well above the specified standard operating pressure of 0.01 mbar. For illustrative purposes, the catalyst-coated membrane pictured in FIG. 11 was made with an argon pressure of 0.2 mbar. The application parameters are of 40 mA, for two 2 minutes applications with a 15 minute pause therebetween, for a total of 240 seconds of application. It will be understood that the above operational parameters are given for illustrative purposes only, and can greatly vary depending on several factors and desired outcome such as: speed of deposition required, the specific sputter-coater used, the specific catalyst being applied, the thickness of the coating desired, and the nature of the membrane.

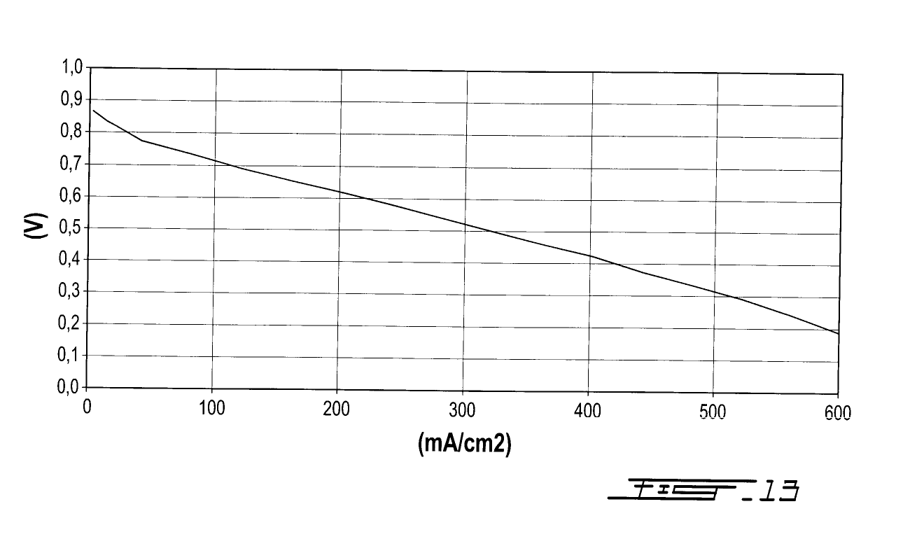

FIG. 12 shows fuel cell performances for an discontinuous platinum coating having semi-contiguous agglomerations with a thickness of about 20 nm, and a loading of 0.1 mg/cm² on the anode side of a hydrocarbon membrane. This catalyst-coated membrane was realized using the Emitech model K575X sputter coater described above at 0.1 mbar argon pressure and a current of 80 mA. An industry standard GDE having a loading of 0.5 mg of platinum/cm² was applied on the cathode side. A 5 cm² sample was tested at 80° C. with a hydrogen pressure of 200 kPa. Hydrogen flowed at 0.1 nlpm on the anode side whereas air flowed at 0.4 nlpm on the cathode side. The performance curve shows a current density of approximately 950 mA/cm² at 0.6V.

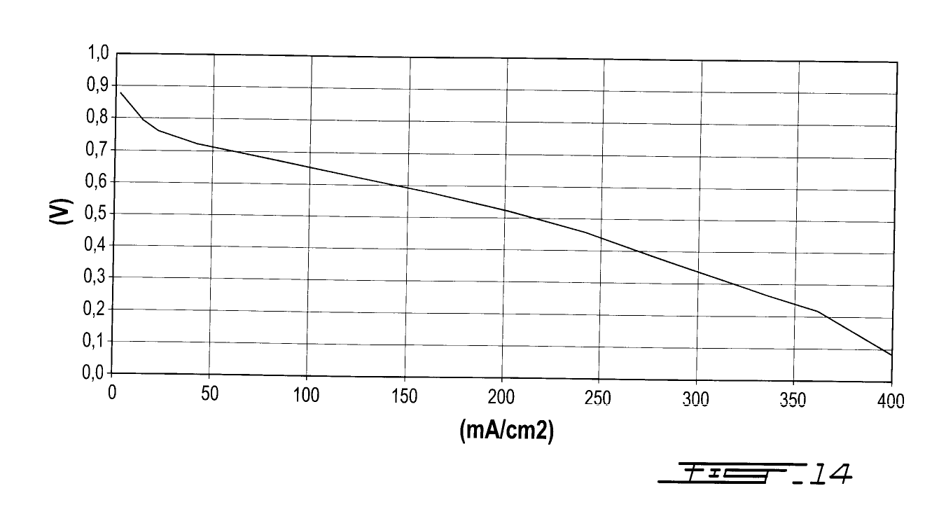

FIG. 13 shows fuel cell performances for a discontinuous catalyst coating of platinum with a loading of 0.1 mg/cm² on the anode side of a fluorinated Nafion® 111 membrane. This catalyst-coated membrane was realized using the Emitech model K575X sputter coater described above at 0.2 mbar argon pressure and a current of 40 mA, with a 200 second application period. An industry standard GDE having a loading of 0.5 mg of platinum/cm² was applied on the cathode side. A 5 cm² sample was tested at 80° C. with a hydrogen pressure of 200 kPa. Hydrogen flowed at 0.1 nlpm on the anode side whereas air flowed at 0.4 nlpm on the cathode side. The performance curve shows a current density of approximately 225 mA/cm² at 0.6V.

FIG. 14 shows fuel cell performances for a discontinuous platinum coating with a loading of 0.2 mg/cm² on the cathode side of a hydrocarbon membrane. This catalyst-coated membrane was realized using the Emitech model K575X sputter coater described above at 0.2 mbar argon pressure and a current of 40 mA, with a 400 second application period. An industry standard GDE having a loading of 0.5 mg of platinum/cm² was applied on the anode side. A 5 cm² sample was tested at 80° C. with a hydrogen pressure of 200 kPa. Hydrogen flowed at 0.1 nlpm on the anode side whereas air flowed at 0.4 nlpm on the cathode side. The performance curve shows a current density of approximately 140 mA/cm² at 0.6V.

In the examples given above and the results graphically depicted, the curves were obtained using a qualified commercial test stand.

Although most examples given above and illustrated demonstrate use of the catalyst coating on the anode side, it will be understood that the catalyst coating can be applied on the cathode side as well. Typically, a greater catalyst loading is used on the cathode side than on the anode side. Also, in alternate embodiments, instead of the hydrocarbon-based membranes and fluorinated membranes which were used in the examples above, the proton exchange membrane can be any suitable alternate media having proton-conducting ability. For example hydrocarbon-based, hydrocarbon composite, per fluorinated such as DuPont's Nafion, composite per fluorinated such as Gore's products, acid based, others known in the industry or to be developed in the future. Further, instead of using a catalyst coating of pure catalyst, alternate embodiments can use other particles mixed in the catalyst coating, or the catalyst coating can have a mixture of catalytic species. The thickness of the catalyst coating can vary. Many other variants can be used in other embodiments. As can be seen therefore, the examples described above and illustrated are intended to be exemplary only. The scope is indicated by the appended claims.

1. A catalyst-coated membrane comprising a proton exchange membrane having two opposite sides, and a catalyst coating applied directly to one of the two sides of the proton exchange membrane, the catalyst coating having a plurality of openings defined therethrough and scattered thereacross, the openings defining passages to the proton exchange membrane in which corresponding electro-chemical active surfaces of the catalyst coating are exposed.

2. The catalyst-coated membrane of claim 1 having a catalyst loading of between 0.01 and 0.15 mg/cm², wherein the one of the two sides is an anode side.

3. The catalyst-coated membrane of claim 2 wherein the catalyst loading is of between 0.02 and 0.08 mg/cm².

4. The catalyst-coated membrane of claim 2 having a performance of at least 600 mA/cm² at 0.6 V when tested in a standard test fuel cell at H2/air industry recognized conditions.

5. The catalyst-coated membrane of claim 4 wherein the performance is of at least 800 mA/cm² at 0.6 V.

6. The catalyst-coated membrane of claim 4 wherein the proton exchange membrane is hydrocarbon-based.

7. The catalyst-coated membrane of claim 1 having a catalyst loading of between 0.1 and 0.35 mg/cm², wherein the one of the two sides is a cathode side.

8. The catalyst-coated membrane of claim 7 wherein the catalyst loading is of between 0.15 and 0.25 mg/cm².

9. The catalyst-coated membrane of claim 1 wherein the catalyst coating has a thickness of less than 200 nm.

10. The catalyst-coated membrane of claim 9 wherein the catalyst coating has a thickness of less than 100 nm.

11. The catalyst-coated membrane of claim 1, wherein the catalyst coating has only active catalytic species.

12. The catalyst-coated membrane of claim 1 wherein the catalyst coating has primarily a noble metal.

13. The catalyst-coated membrane of claim 12 wherein the catalyst coating has only platinum.

14. The catalyst-coated membrane of claim 1 wherein the openings are defined in a regular array across the catalyst coating.

15. The catalyst-coated membrane of claim 1 wherein the openings are irregularly scattered across the catalyst coating.

16. The catalyst-coated membrane of claim 1 wherein the openings are elongated, non-straight, and of varying widths and lengths, and are irregularly scattered on the catalyst-receiving surface, and the catalyst coating forms an irregular agglomerational structure on the proton exchange membrane.

17. The catalyst-coated membrane of claim 16 wherein the openings have between 1 nm and 15 nm in width on average.

18. The catalyst-coated membrane of claim 16 wherein the irregular agglomerational structure has semi-contiguous agglomerations having between 5 nm and 40 nm on average.

19. The catalyst-coated membrane of claim 1, wherein the catalyst coating has an electrochemical catalyst surface area of between 10 and 80 m²/g.

20. The catalyst-coated membrane of claim 19 wherein the electrochemical catalyst surface area is of between 20 and 60 m²/g.

21. The catalyst-coated membrane of claim 19 having a performance of at least 600 mA/cm² at 0.6 V when tested in a standard test fuel cell at H2/air industry recognized conditions.

22. The catalyst-coated membrane of claim 21 wherein the performance is of at least 800 mA/cm² at 0.6 V.

23. The catalyst-coated membrane of claim 21 wherein the proton exchange membrane is hydrocarbon-based.

24. The catalyst-coated membrane of claim 1 wherein the proton exchange membrane is non-fluorinated.

25. The catalyst-coated membrane of claim 1 wherein the catalyst coating is electrically conductive.

26. The catalyst-coated membrane of claim 1 further comprising an other catalyst coating, the other catalyst coating being applied directly to the other one of the two sides.

27. A method of making a catalyst-coated membrane having a proton exchange membrane with two opposite sides, and a catalyst coating, the method comprising:
applying the catalyst coating directly to one of the two sides of the proton exchange membrane; and
subsequently defining a plurality of openings through the catalyst coating and scattered across the catalyst coating, thereby creating passages to the proton exchange membrane and exposing electro-chemical active surfaces of the catalyst coating.

28. The method of claim 27 wherein the catalyst coating applied in the step of applying is continuous.

29. The method of claim 27 wherein the catalyst coating applied in the step of applying is discontinuous.

30. The method of claim 27 wherein the one of the two sides of the proton exchange membrane has a roughness greater than a thickness of the catalyst coating applied to it in the step of applying, and the applied catalyst coating has high points corresponding to the roughness, and wherein the step of defining a plurality of openings includes abrading the high points.

31. The method of claim 30 further comprising inducing the roughness in the catalyst-receiving surface of the proton exchange membrane prior to the step of applying.

32. The method of claim 31 wherein the step of inducing the roughness in the catalyst-receiving surface includes depositing fine inorganic particles in a scattered manner thereon.

33. The method of claim 31 wherein the step of inducing the roughness in the catalyst-receiving surface includes mixing inorganic particles in the material of the proton exchange membrane, and casting the membrane in a manner that some of the inorganic particles migrate to the surface of the membrane, creating the roughened membrane surface.

34. The method of claim 27 wherein the step of defining the plurality of openings includes vaporizing catalyst.

35. The method of claim 30 wherein the step of vaporizing catalyst is effected using a laser beam.

36. The method of claim 27 wherein the step of defining the plurality of openings includes swelling the proton exchange membrane, thereby fissuring the catalyst layer and defining the plurality of openings.

37. A method of making a catalyst-coated membrane having a proton exchange membrane with two opposite sides, and a catalyst coating, the method comprising:
applying a deliberately discontinuous layer of the catalyst coating directly onto the one of the two opposite sides of the proton exchange membrane in a manner that a plurality of scattered openings providing passages to the proton exchange membrane are defined through the applied catalyst coating, with electro-chemical active surfaces of the catalyst coating exposed in the openings.

38. The method of claim 37 wherein the step of applying the deliberately discontinuous layer of catalyst includes sputter-coating the catalyst.

39. The method of claim 38 wherein the step of sputter-coating includes sputter-coating at pressure conditions set above predetermined operational parameters.

40. The method of claim 38 wherein the step of sputter-coating is effected at a pressure above 0.05 mbar.

41. The method of claim 40 wherein the pressure is equal to or above 0.1 mbar.

42. The method of claim 41 wherein the pressure is of about 0.2 mbar.

43-46. (canceled)
